(19) United States
(12) Patent Application Publication
(10) Pub. No.: US 2003/0220705 A1
(43) Pub. Date: Nov. 27, 2003

(54) Audio distribution system with remote control

(76) Inventor: Jarry A. Ibey, Whittier, CA (US)

Correspondence Address: Chris Papageorge, 14625 S. Vermon #5, Gardena, CA, 90247, US

(21) Appl. No.: 10/155,942

(22) Filed: May 24, 2002

(51) Int. Cl. G06F 17/00

(52) U.S. Cl. 700/94

(57) ABSTRACT

A system for distributing audio in the form of music and paging to a multitude of speakers placed at various locations inside or outside of a building. The system includes a host controller which receives music and paging signals, processes the signals and transmits the signals to pass modules mounted on the speakers. The pass modules process and amplify the signals and transmit them to the speakers which are stereo capable enabling them to simultaneously broadcast the music and paging signals if and when desired. A hand held remote control allows a user to transmit an infrared signal to electronic control modules mounted on the speakers and connected to the pass modules and make operational adjustments of speaker outputs characteristics such as equalization, contour, etc. The system also includes a computer which is connected to the host controller for control of desired signal outputs to the speakers as well as desired signal inputs to the host controller. The computer also receives feedback signals from microphones in the electronic control modules for monitoring of the area at the speakers and for control of operational parameters of the speaker outputs.

### BACKGROUND OF THE INVENTION

The invention relates generally to audio distribution systems providing paging and music to various locations inside or outside of a building. The invention more particularly relates to a system which provides control over many characteristics of the audio output including remote control of the audio output of each speaker from the area of that speaker.

Conventional PBX systems and other similar systems which distribute music to multiple speakers at various locations require the use of large and often expensive head-end power amplifiers. These amplifiers have their outputs stepped-up to either a twenty-five volt or seventy volt line output. These outputs are in turn connected to one or several speakers via two conductor wiring with only the availability of a single channel or voice path through which both the music and paging signals are distributed to all the speakers. Each speaker has a line matching transformer which steps down the audio signal to match the speakers' eight ohm load. The only means of controlling volume for these speakers is either changing the master gain of the main amplifier which consequently changes the volume of every speaker attached to that amplifier or dragging out a ladder or scaffold to reach the speaker and physically move a volume control knob or reconfigure the wiring on the transformer tap-off. Also, basic contour controls for bass and treble are available only at the main amplifier and the master volume control of the main amplifier adjusts the output to all speakers simultaneously and collectively.

Some types of speaker units allow adjustment of contour but they require manual adjustment of a knob. Others allow screwdriver adjustment of a control typically located at the back of the speaker unit necessitating lowering or otherwise removing the speaker from the ceiling or other enclosure to gain access to that screwdriver actuated control or i:o change the transformer tap-off. Since many such speaker units are placed in ceilings, such adjustments require a person to climb a ladder or scaffold to reach them and often require removal of ceiling tiles in order to make the desired contour adjustments. This task may thus result in a messy clean up job for the worker as well as the work site. In some instances, a transformer tap-off winding has to be changed which is usually on the top side of the speaker and thus performing the desired change is very difficult or time consuming. This change usually requires the speaker unit to be lowered from the ceiling requiring the removal of ceiling tiles in order to make the desired contour adjustments. This task may thus be time consuming and labor intensive and present a messy clean up job for the worker as well as the work site in addition to presenting the potential for aesthetic damage to the site.

There are many other problems with this type of prior art system design that relate to performance and reliability. Each speaker in the wire run loads the entire system and consequently the last speaker in the series connection suffers the most performance degradation. The last speaker is thus likely to have the worst fidelity, lowest voltage due to line loss, poorest dynamic range, highest level of undesired noises, hums and the like. Consequently, the poor quality of the audio output prompts many listeners to turn down or turn off the speaker outputs. In addition, since all the speakers are connected in series to individual amplifiers, failure of the main amplifier results in loss of speaker function for every speaker connected to that amplifier. Since such systems are not usually supervised as to their integrity, they many fail without anyone being aware. Testing such systems usually requires the PBX operators to make test pages multiple times which detracts from their other duties and also may become a nuisance to the listeners.

This type of prior art system also lacks separate adjustment of the music and paging signals. If the music output is turned down, the paging output is concurrently turned down. However, different circumstances and situations require that the paging be either louder or softer than the music.

There are many types of systems that have addressed the problem of controlling audio output where the device to be controlled is inaccessible. Remote control units emitting an infrared signal have been utilized to control audio components in various system layouts. An example of a system using a remote control unit transmitting an infrared signal to a sensor mounted in a speaker is disclosed in U.S. Pat. No. 5,815,108 to Terk. The Terk system controls a characteristic of the accoustic output and thus provides a basic function of controlling the audio system from the speaker housing. However, the Terk system uses a method of converting the infrared signal to an RF signal and transmiting it through a succession of cables to an audio component such as a video cassette recorder. But, Terk is not capable of controlling parameters of speaker output directly at the speaker. Thus, Terk instead simply extends the range of an infrared transmitter with the objective of otherwise conventionally controlling the audio component which operates the speaker.

Other types of remote control audio systems control various parameters of audio output. U.S. Pat. No. 5,625,608 to Grewe discloses a remote control audio system that provides remote access of audio content information contained in the recorded medium. The Grewe invention utilizes a microprocessor in the remote unit to provide the user with information regarding the content of the recording e.g., the recording artist or musical category of the music selection stored in the music chip storage medium of an audio player. However, the Grewe invention does not control any parameters of speaker output directly at the speaker.

Still other types of audio systems utilize an infrared signal transmitted to the speakers. An example of such a system in which an infrared signal containing audio information is sent to the speakers is disclosed in U.S. Pat. No. 4,899,388 to Mlodzikowski. The Mlodzikowski invention uses an amplifier which sends its audio signals directly to a a pair of speakers in the system without the use of wires. The system includes a means in each of the speakers for separating and selecting out that portion of the infrared signal containing the stereophonic signal component for each one of the speakers and emitting the resulting sound output: therefrom. But, the Mlodzikowshi system is only capable of transmitting audio signals to the speakers. Mlodzikowski is not capable of transmitting control signals to the speakers. In addition, Mlodzikowski is not capable of independent and separate control of the individual speakers.

What is therefore needed is an audio system which can control various operational parameters of speaker output at the individual speaker. What is also needed is such a system which can provide such control from a location remote from the speaker. Such a system is also needed that can provide independent and separate operational control of any individual speaker of a set of speakers each of which is in a separate location from the others.

### SUMMARY OF THE INVENTION

It is a principal object of the present invention to provide a music and paging system incorporated in a local area network system.

It is also an object of the present invention to provide a music and paging system in which the amplifiers driving the set of speakers are located at each individual speaker.

It is another object of the present invention to provide a music and paging system having unitary subassemblies mounted directly on the speakers which provide direct operational control of the speaker on which mounted.

It is another object of the present invention to provide a music and paging system having unitary subassemblies mounted directly on the speakers which provide direct control of desired characteristics of speaker output of the speaker on which mounted.

It is another object of the present invention to provide a music and paging system having unitary subassemblies mounted directly on the speakers which provide self diagnostic features for the speaker on which mounted.

It is also an object of the present invention to provide a music and paging system providing independent control of the music and paging signals transmitted to each speaker and providing such control at each individual speaker and separate from that of the others.

It is an object of the present invention to provide remote control of desired parameters of speaker operation and function of each individual speaker to eliminate the need for a user to make physical contact with the speaker subsystem in order to make system adjustments thereto.

It is an object of the present invention to provide remote control of self diagnostic features of the speakers.

It is an object of the present invention to provide a music and paging system in which the speakers thereof incorporate electronic controls therefor.

It is an object of the present invention to provide a music and paging system providing low voltage output to the speakers thereof to eliminate the need for conduit for the wiring.

It is an object of the present invention to provide a music and paging system utilizing twisted pair wiring.

It is an object of the present invention to provide a music and paging system having remote control enabling individual and independent speaker adjustments directly from a listener's vantage point.

It is an object of the present invention to provide a music and paging system which does not incorporate transformers for improved audio quality.

It is an object of the present invention to provide a music and paging system with indicator lights at the speakers to provide an indication of desired operational and functional parameters thereof.

It is an object of the present invention to provide a music and paging system having supervisory features of components thereof.

It is an object of the present invention to provide a music and paging system having components obtaining their power from uninterruptible power sources.

It is an object of the present invention to provide a music and paging system wherein the speaker subsystems thereof each have unique ID addresses for enabling independent and separate control of each of the speaker subsystems thereof from a host controller.

It is an object of the present invention to provide a music and paging system which can accept audio inputs from various types of sources.

It is an object of the present invention to provide a music and paging system which can accept various types of digital and analog signal inputs.

It is also an object of the present invention to provide a music and paging system which incorporates a microphone in the speaker subsystems for testing system and subsystem performance, monitoring the surrounding area of the speakers and for providing two way communications with the surrounding area of the speakers.

It is an object of the present invention to provide a music and paging system which incorporates energy saving circuitry which automatically scales back power consumption when appropriate.

It is an object of the present invention to provide a music and paging system which incorporates on-board circuitry to provide priority override of the music signals and to provide variable muting of the music signals with smooth start and stop.

It is an object of the present invention to provide a music and paging system which incorporates software for operation thereof.

It is an object of the present invention to provide a music and paging system which incorporates on-board digital signal processing at the speaker subsystems to shape and contour audio signal output and eliminate undesirable artifacts.

It is an object of the present invention to provide a speaker subsystem having heat dissipation structures therefor.

It is an object of the present invention to provide a music and paging system having speakers with enclosures for resisting corrosion and contaminants and eliminate the risk of short circuiting.

It is an object of the present invention to provide a music and paging system facilitating installation of the speakers thereof into existing speaker locations.

It is an object of the present invention to provide a music and paging system having programmable clocks for initiation of desired signal outputs.

It is an object of the present invention to provide a music and paging system utilizing removable plug connectors to facilitate installation, replacement and switching of components thereof.

It is an object of the present invention to provide a music and paging system having digitally transmitted audio content for enhanced audio quality.

It is an object of the present invention to provide a music and paging system having queing capability for issuing desired paging signals at appropriate times.

It is an object of the present invention to provide a music and paging system having a library of preconfigured, synthetic messages for issuing such messages as and when desired.

It is an object of the present invention to provide a music and paging system having a modem for transmitting and receiving signals to and from external devices and computers.

It is an object of the present invention to provide a music and paging system having speaker subsystems having daughterboard ports for adding on various desired features thereto.

It is an object of the present invention to provide a music and paging system having speakers with two voice coils for simultaneously broadcasting music and paging and other types of audio signals therefrom.

The system of the present invention is especially well adapted for use as an improved multifunctional PBX system in a facility such as a hospital, school, business office, etc. which has a multitude of rooms, offices, locations and the like which require communication with a central office or other such location. The system is specifically designed to provide a more flexible, practical and multi-featured means of distributing various audio content to various rooms or other locations both inside and outside of a building. The system is basically a local area network incorporating a host controller feeding audio and control signals to a set of speaker subsystems placed in various rooms or other desired locations. The host controller receives its audio signal inputs from any type of desired audio source but preferably from a PBX source and a music source such as a radio. These input signals are digitally processed and transmitted via a wiring network such as a bus to the speaker subsystems. Each speaker subsystem includes a pass module which processes, amplifies the signals and feeds them to the speaker thereby broadcasting the paging and/or music signals into the rooms or other locations. The incorporation of an amplifier in the pass module instead of at the central control unit of conventional PBX systems obviates the need for coupling transformers between the host controller and the speaker subsystems. Coupling transformers may have frequency response that is greatly inferior to that of the speaker thereby sharply reducing the frequency range of the signal fed to the speaker. Absence of such coupling transformers consequently provides enhanced frequency response as well as enhanced dynamic range, clarity, etc. Absence of such transformers also reduces feedback related problems because of smooth speaker cone movements and absence of transformer crossover distortion which are primary causes of feedback. Additionally, this reduces noises as well as EMI and EMF interference caused by changing and collapsing magnetic fields of the coil windings. Also, neighboring speakers do not receive transformer induced noises. In addition, the lack of a transformer in the system provides improved energy efficiency over prior art systems which require the use of a transformer to step up the signal from the main amplifier for transmission through the wiring to the speaker and subsequent use of a transformer to step down the signal going directly into the speaker to match the speaker's eight ohm load requirement. It is also a primary shortcoming of transformers that they are often failure prone due to their incorporation of very fine wires in their windings which commonly break open or short to adjacent wires. In this regard, a short in a transformer may adversely affect the speaker directly connected thereto as well as neighboring speakers and sometimes may short out the main amplifier resulting in failure of the entire system. Another important shortcoming of transformer usage is that the transformers cause undesirable loading of branch circuits i.e., each additional transformer outfitted speaker pulls down the signal so that the furthest speaker suffers the most in that it characteristically suffers reduced signal, unwanted artifacts induced by previous transformers plus line-loss, noise, hum, interference, distortion and signal degradation with the net result being poor audio clarity and intelligibility with such adverse effects increasing with the distance from the main amplifier. Elimination of the use of transformers allows the host controller to transmit relatively low voltage output signals to the wiring network. Consequently, the wiring required for such low voltage output is relatively inexpensive wiring, and such wiring does not require conduit. Thus, since the system does not use transformers, it is able to provide high quality performance with reduced cost and with minimal repair and maintenance costs.

Each speaker subsystem also includes an electronic control module connected to the pass module for operational control thereof. The electronic control module is mounted on the face of the speaker and includes an sensor for receiving an wireless control signal from a remote control unit. The remote control unit is compact allowing it to be handheld by a user who can walk around with it to each and every room in which any speaker is located. By simply pointing the remote control unit at the speaker subsystem thereof and actuating the remote control unit to emit the control signal, the user can thereby make adjustments to the speaker such as raising or lowering its sound volume, altering the bass, middle or treble output or raising or lowering the music output relative to the paging output or vice versa. The system thus allows independent and separate adjustment of output parameters of each and every speaker to be made directly at the speaker by a user who is positioned where a typical listener is positioned thereby allowing a realistic assessment of speaker performance before as well as while making adjustments thereto. This feature is advantageous because it allows the remote control user to turn down the music in some locations where deemed too loud and turn it up in other locations where deemed not loud enough in accordance with the preferences of the occupants of that particular room, the accoustic characteristics of the room or with management's needs. This feature is also advantageous because it also allows the remote control user to turn up or down the paging as befits the requirements or preferences of any particular location independently of the volume level of the music. In addition, since these adjustments can only be made by means of the remote control, unauthorized persons are precluded from making alterations to the speaker output. It is also very important that the adjustments to volume, contour and equalization are made without the need for the rheostats or other controls used in conventional audio distribution systems thus eliminating the problems relating to longevity and reliability that such mechanical controls inherently possess.

Each speaker has two voice coils to enable reception of two separate signals. This allows each speaker to be able to broadcast paging and music simultaneously with the parameters of each adjusted independently and separately from the other. Additionally, this allows the music to be separated from the paging signal to enable some locations to receive music only or paging only, if and as desired.

Each pass module includes circuitry that provides various types of automatic alteration of the sound output such as muting and ducking. Each pass module also includes other types of circuitry that provide other useful features that facilitate the operation, adjustment and maintenance of the system.

A computer is connected to the host controller and allows control of various functions of the controller. The computer also allows the control of the controller by various other possibly remote computers via a modem connection. The computer and modem also allow the system to communicate via computer with remote sites. This enables the system to automatically communicate system malfunctions or other troubles directly to a service facility and also enables system interrogation from a remote laptop computer.

### BRIEF DESCRIPTION OF THE DRAWINGS

FIG. 1 is a block diagram of the distribution system showing the host controller thereof connected to other components of the system and also showing the host controller receiving inputs from audio and control sources.

FIG. 2 is a side perspective view of the speaker subsystem of the invention showing the speaker grill separated from the main speaker components and also showing the remote control which is used to transmit signals to the speaker subsystem.

FIG. 3 is a front perspective view of the pass module component of the speaker subsystem showing details thereof and showing a daughterboard separated from its plug in receptacle on the main body of the pass module.

FIG. 4 is a sectional view of the connector and heat transfer structures of the pass module taken along lines 4-4 of FIG. 3.

FIG. 5 is a side perspective view of the electronic control module of the speaker subsystem.

FIG. 6 is a bottom perspective view of the electronic control module of FIG. 5.

FIG. 7 is a block schematic diagram of the pass module of FIG. 3.

FIG. 8 is a block schematic diagram of the electronic control module of FIGS. 5 and 6.

FIG. 9 is a block schematic diagram of the host controller and computer components of the invention showing their interconnection and also showing the audio and control signal sources and their connections to the host controller.

FIG. 10 is a flow chart of the software program of the host controller component of the invention utilized to acquire input signals and distribute selected audio and control signals to selected individual speaker subsystems or to entire speaker subsystem network.

FIG. 11 is a flow chart of the software program of the pass module component of the invention utilized to acquire signals from the host controller and other sources and adjust desired parameters of speaker subsystem operation and function.

### DETAILED DESCRIPTION OF THE PREFERRED EMBODIMENT

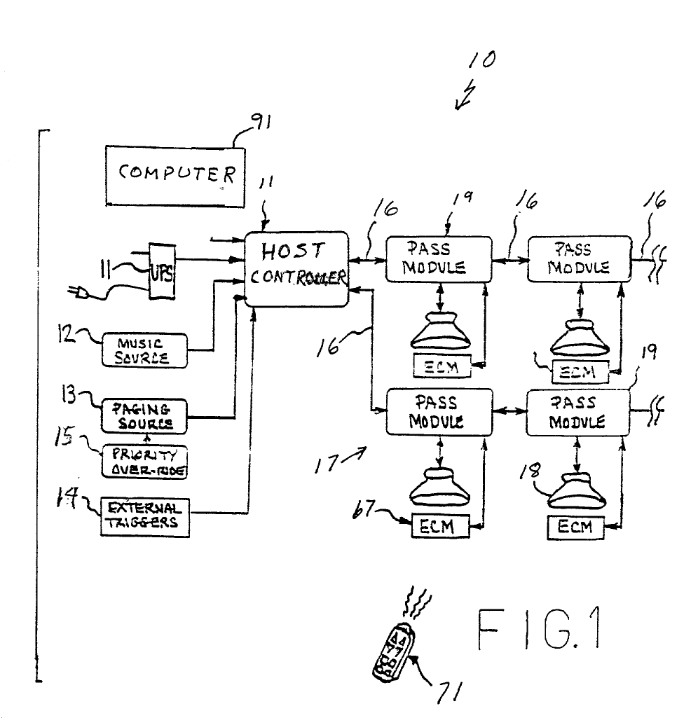

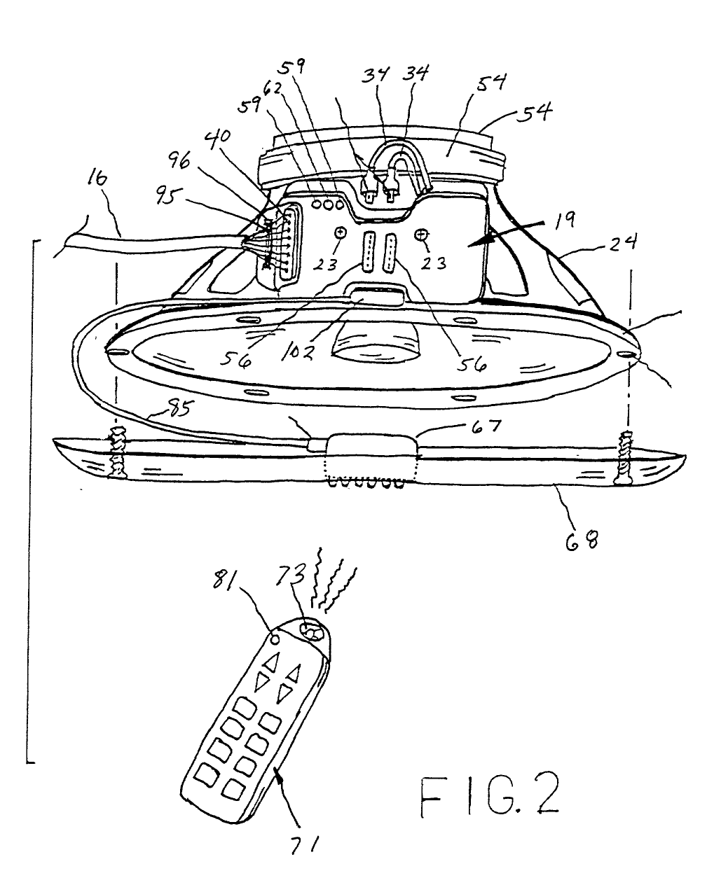

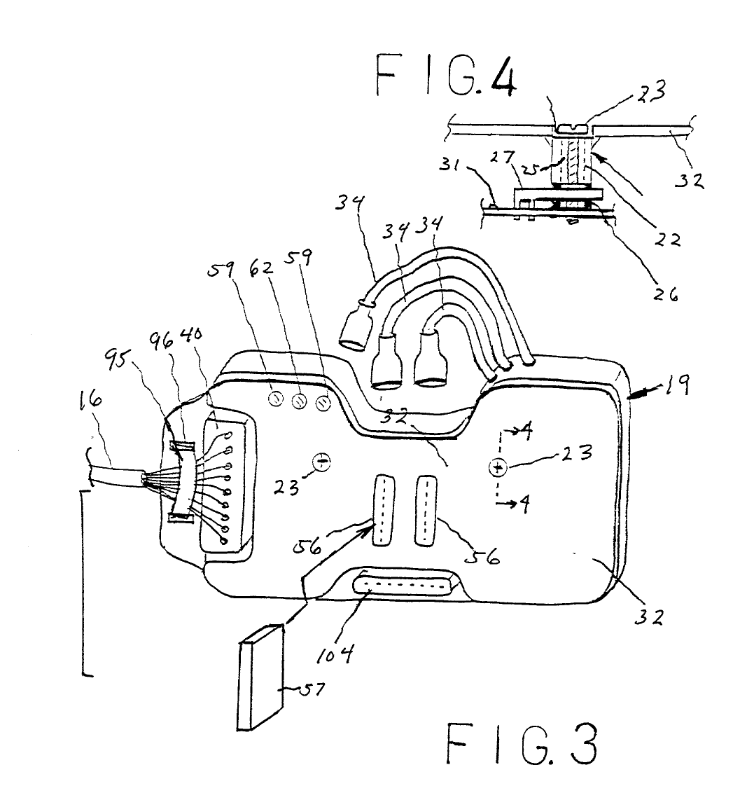

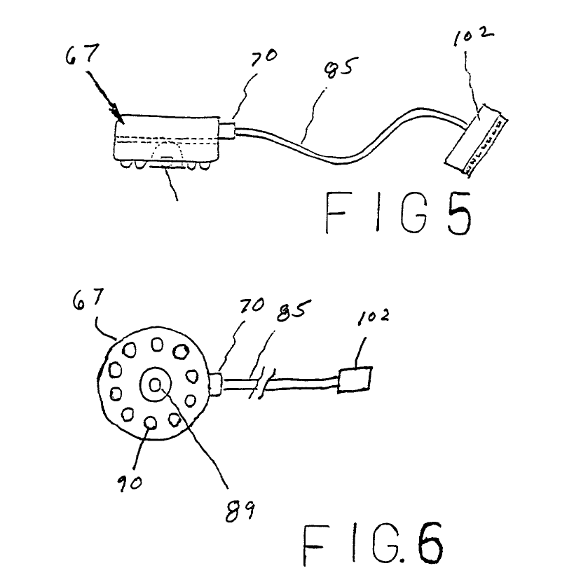

Referring to the drawings, FIG. 1 shows the audio distribution system of the present invention generally designated by the numeral 10. Audio distribution system 10 includes a host controller 11 which receives inputs in the form of audio signals from music source 12 and paging source 13. The music source 12 may be, for example, a cd player, a tuner, a satellite dish, a cable receiver, a tape player, an internet music source, etc. Similarly, the paging source 13 may be, for example, a radio, a microphone, an internet communication source, a telephone, etc. Host controller also receives input in the form of a trigger signal from external trigger source 14. The external trigger source 14 sends a signal to the host controller 12 to process a signal or acquire a signal from memory to process and broadcast. The paging source 13 receives input from a priority override source 15 which adds a control signal to the output from the paging source 13 which serves to suppress some signal outputs from the paging source 13 and/or boost other signal outputs therefrom in order to, in effect, override audio signal outputs deemed relatively unimportant and give priority to audio signal outputs deemed relatively more important or urgent.

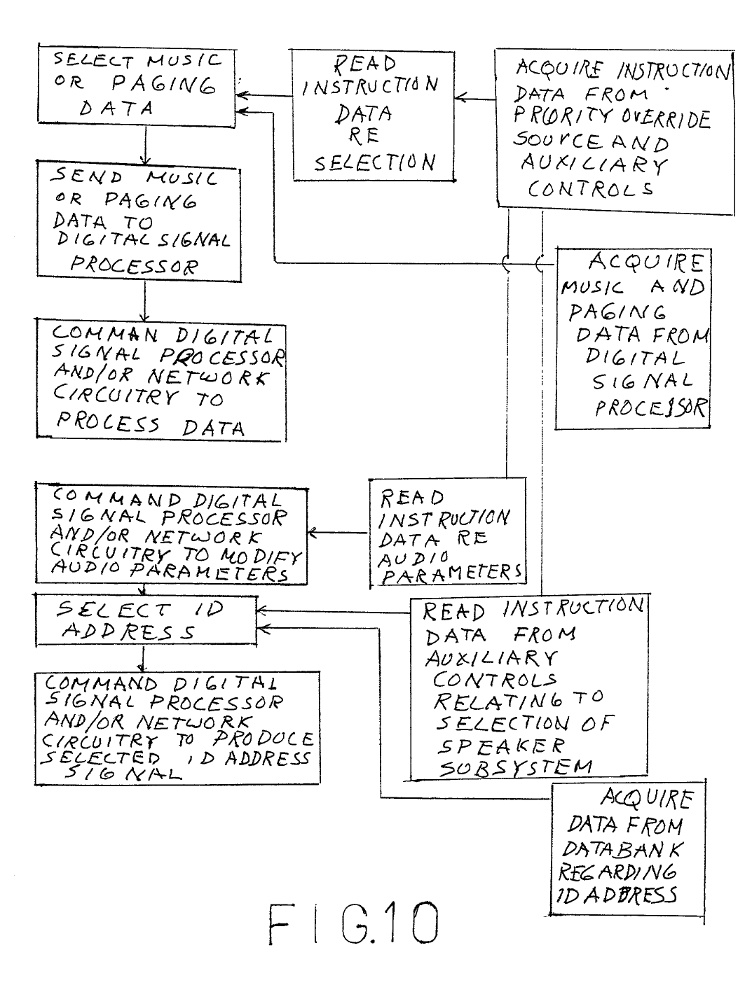

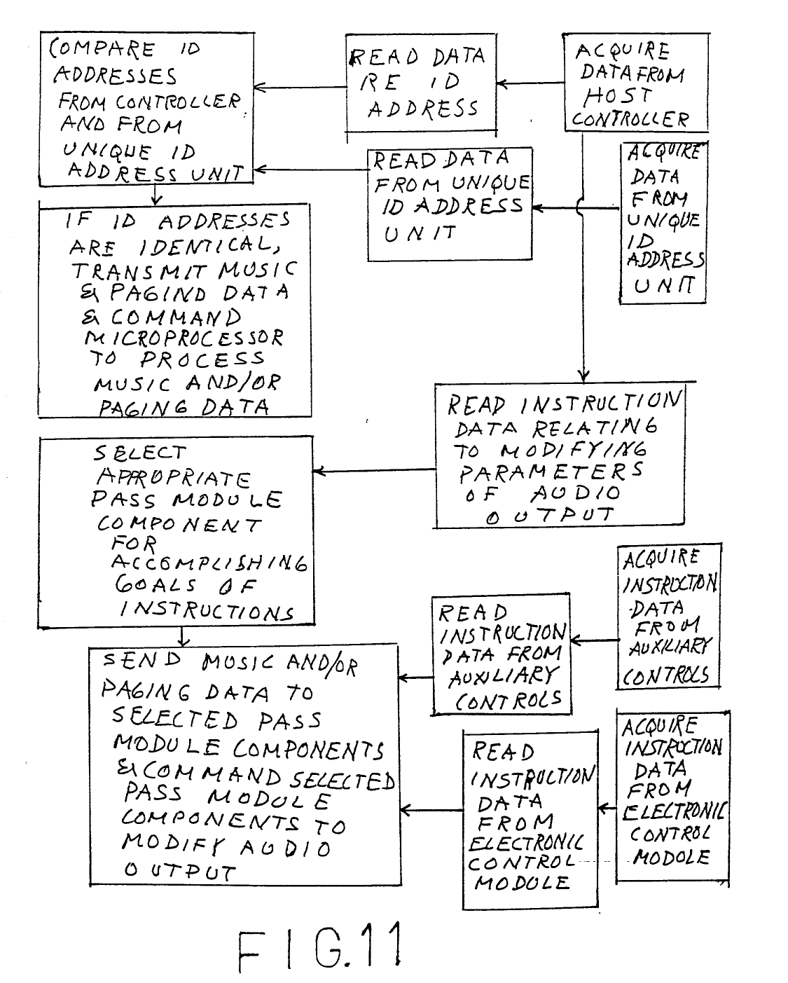

The host controller 11 is also connected to a wiring network which is preferably a bus 16 or a pair of buses 16, as shown in FIGS. 1 and 9. Each bus 16 feeds the output from the host controller 11 to speaker subsystems 17. The bus 16 connects the speaker subsystems 17 in series. The bus 16 may be twisted pair telephone wiring. The speaker subsystems 17 are each located in a room or other location in a facility such as a hospital or other building where distributed music and paging is desired. The speaker subsystems 17 may be positioned in the ceiling where they are generally out of the way, [where they are unlikely to be obstacles and unlikely to be tampered with] as with conventional music and paging distribution systems. There may be any number of speaker subsystems 17 in accordance with the number of rooms or other suitable locations in which music and paging are desired. In addition, the speaker subsystems 17 may be located outside of a building, such as at a playground, if music and paging are desired there.

Each subsystem 17 includes a speaker 18 and a pass module 19 mounted on the speaker and electrically connected thereto for operational control thereof. Each pass module 19 incorporates an amplifier 20 to drive the speaker 18 on which the pass module is mounted. This obviates the need for one or more main amplifiers driving all the speakers 18 from a central control unit. This consequently also obviates the need for relatively high voltage wiring from the host controller 11 (or other such central control unit) to the speakers 18 as well as the need for conduit to carry such [relatively high voltage and thus] potentially dangerous wiring. This also provides high quality audio output even over long distances from the controller 11 to the speakers 18 as compared to conventional systems using a main amplifier which have especially degraded audio quality when feeding a large number of speakers over very long wire runs.

The amplifier 20 is preferably a chip 20 which is mounted on and part of a circuit board 21. The circuit board 21 is attached to the speaker 18 by means of an attachment post 22 which is hollow and generally in the form of a sleeve to act as a guide in allowing an attachment bolt 23 to pass through and attach the post 22 and circuit board 21 to the frame 24 of the speaker 18. An insert 25 is provided in the hollow area to prevent the attachment bolt from being inserted at a skewed angle and short against printed circuit board or associated components. The post 22 is provided with an opening 26 at a lower, lateral side portion thereof which exposes a portion of the bolt 23 when inserted therein. The opening 26 is positioned and dimensioned to engage a heat transfer structure 27 at its one end 28. The other end of the heat transfer structure 27 has clips 29 which mate with corresponding clip receptacles 30 on the circuit board 21 so that the board 21 can easily clip into position on the post 22 and therefor on the speaker 18. When the bolt 23 is in the post 26 and attaching the board 21 to the speaker 18, the end 28 of heat transfer structure 27 is in contact with the bolt thereby allowing heat from the power amplifier 20 integrated circuit of the circuit board 21 to be transmitted through the circuit board traces and through the transfer structure 27 and bolt 23 into the frame 24 of the speaker 18. This turns the speaker frame 24 into a large heat sink structure. The top cover 32 of the pass module 19 also includes two recesses 33 allowing the bolt head to rest sub-terrainially to the facia or planar surface of top so as to prevent interference with superimposable daughterboards and to prevent short circuiting to the underside of the daughterboard modules. Attachment post 22 also serves as an anti-compression structure preventing overtightening and crushing of the pass module 19. The bolt locations are located and spaced so as to be universally attachable to a multiplicity of speaker brands having preconfigured bolt holes for the seventy volt audio transformer (not shown) which the present invention replaces. The pass module 19 is attached to the speaker frame 24 at the same location formerly occupied by antequated seventy volt line transformer (not shown) used in prior art devices. The pass module 19 is of contoured shape and design to snugly fit just below the speaker connecting tabs so as to minimize the length of the cable pigtails 34 and to maximize the use of available space wherein pass module 19 is still small enough for most speaker back cans (not shown) to fit over the speaker 218 and pass module 19.

The system 10 is basically a local area network with the host controller 11 performing various data processing functions in order to operate the speakers 18 in accordance with programmed instructions. As shown in FIG. 9, controller 11 is powered by an uninterruptible power source 35 and includes buffer isolators 36 and 37 for receiving the inputs from the music source 12 and paging source 13. The buffer isolators 36 and 37 provide outputs which are transmitted to a digital signal processor 38 which also includes a codec for converting analog telephone signals into digital form. The digital signal processor 38 processes the outputs from the sources 12 and 13 and feeds them to network circuitry 39. The network circuitry 39 further processes and encodes the signals and feeds them into a bus converter 105 and into and through wiring networks 16 which are preferably a plurality of buses 16. Each bus 16 connects the host controller 11 to a plurality of pass modules 19 in a series connection.

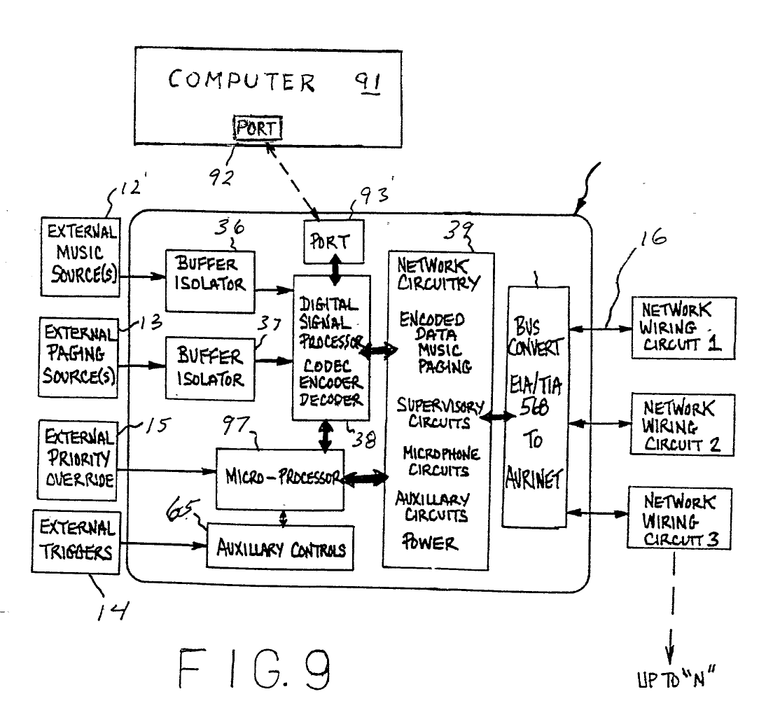

The digital output signals are transmitted through mains wiring connectors 40 into the pass modules 19 each of which is basically a circuit assembly which includes a lan interface 41 which receives the digital output signals and feeds them to a microprocessor 42, as shown in FIG. 7. The microprocessor 42 decodes and processes music, paging and electronics instructions and generally performs as the main controller for the pass module 19. Each pass module 19 is provided with an ID address which is distinct from that of the other pass modules enabling the host controller 11 to recognize each pass module by way of this address. The microprocessor 42 feeds the encoded digital audio signals from the host controller 11 to a digital signal processor 43 which also includes a codec 44 for converting the digital telephone signals into analog form suitable for driving an audio transducer. The digital signal processor 43 and codec 44 thereof also control bass, treble, equalization and other frequency response settings. The digital signal processor 43 feeds the analog outputs to voice path decoders 45 which decode the signal therefrom to separate the signal from the music source from the signal from the paging source in accordance with preprogrammed instructions from the microprocessor 42. After the music and paging have been separated, the signals are fed to volume intensity controls 46 and 47 which are able to individually adjust the sound amplitude or intensity in accordance with preprogrammed instructions from the microprocessor 42. Preferably, volume intensity control 46 controls the paging amplitude while volume intensity control 47 controls the music amplitude. The outputs from the volume intensity controls 46 and 47 are fed to mute and periscope circuit 48 and mute and ducking circuit 49 which mute, periscope and duck the appropriate signals under certain conditions in accordance with preprogrammed instructions from the microprocessor 42. The resulting outputs are fed to mixer and combiner 50 which mixes and combines the two signals into a single signal form suitable for driving the speakers while retaining them in two channel (or two voice path) form and feeds them to speaker supervisor circuit 51 and from there to amplifier 52 which steps up the voltage of the signals and feeds them to the speaker 18 in two channel form via speaker connectors 53. The speaker 18 preferably has two voice coils 54 in order to simultaneously broadcast both the music and the paging signals.

The pass module 19 also includes a test signal circuit 55 which generates pre-configured test signals consisting of a test signal, a sweep signal and a white noise signal. The signal output from test signal circuit 55 is fed to the mixer and combiner 50 for emitting a corresponding audio output from the speaker for the purpose of quickly and easily testing the speaker output for operation, frequency response, etc.

The pass module 19 also has a daughterboard interface port or socket 56 or, more preferably, a plurality of such interface ports 56 for plugging daughterboards 57 into the pass module which can add various additional functions, features, controls and interfaces to the pass module 19. The ports 56 are reverse wired so that left or right orientations mate identically to any daughterboard module. The daughterboards can be easily plugged into the pass module 19 and also easily removed therefrom so quickly add or detract certain functional features to or from the pass module 19. Thus, the separated music and paging content are fed into a mixer-combiner circuit 50 along with other reproducible content from the daughterboard 57 depending on the type of daughterboard module inserted.

The pass module 19 also includes power supervision circuit 58. The power supervision adjusts the electrical power going into the pass module 19 and signals the host controller 11 of a fault condition and display on led 59 a fault condition. Power for the pass modules 19 is received from an uninterruptible power supply (not shown) through mains wiring connector 40 at preferably twenty-four volts D.C. and stepped down and filtered by two on-board power supplies comprising a power supply low 60 and a power supply high 61 which transmit an operative current to status leds 62 to notify of the power supply condition.

The pass module 19 also includes auxiliary control 63 for receiving the external trigger source 14 and processing and feeding it to microprocessor 42. In response to the input from the external trigger source 14 and in accordance with preprogramned instructions, the microprocessor 42 modifies the outputs of decoders 45, intensity controls 46 and 47 or mute circuits 48 and 49. For example, the paging amplitude may be automatically augmented or muted by the mute circuits 48 or 49. Similarly, the music amplitude may also be auxiliary command controlled to either mute entirely or duck which a variable mute depth by the mute and ducking control 48 or 49.

The host controller 11 similarly includes auxiliary control 63 for receiving the external trigger source 14 and processing and feeding it to microprocessor 97. The microprocessor 97 also receives input from the external priority override source 66. In response to the input from the external trigger source 14 and/or the priority override source 66 and in accordance with preprogrammed instructions, the microprocessor 97 modifies the outputs of digital signal processor 98 and/or network circuitry 99 thereby altering the audio signal output going to the speaker subsystems 17.

Each speaker subsystem 17 also includes an electronic control module 67. The speaker subsystems 17 are thus basically self-contained loudspeakers outfitted with the subassemblies comprising pass module 19 and electronic control module 67. The control module 67 preferably includes an enclosure and an internal circuit board (not shown). The control module 67 is designed to work in concert with the pass module 19 in bi-directional fashion. It serves as an interactive apparatus for individual speaker control. The electronic control module 67 is mounted on the speaker 18 preferably on the face or, more preferably, the grill 68 thereof. The control module 67 is positioned on the centerline of the grill 68 at a location where a rheostat volume control would be placed in similar conventional speakers. The electronic control module 67 is of approximately the same dimensions as a rheostat so as not to block an excessive number of speaker grill holes and so as not to interfere with the physical movement of the cone of the speaker 18. The electronic control module is preferably strain-reliefed 70 so as to minimize wiring damage caused by speaker vibrations. The positioning of the control module 67 on the grill 68 makes it easily able to receive a wireless control signal emitted by a remote control unit 71.

The remote control transmitter (unit) 71 is similar to a conventional remote control unit used for controlling video cassette recorders in that it has buttons 72 on its face for controlling volume and is battery powered. In addition, the remote control unit 71 has buttons for controlling test signal generation, sweep signal generation and white noise signal generation for testing the speakers at will. Also, the remote control unit 71 has separate control buttons for separately controlling the music and paging outputs which are transmitted through two separate channels. The buttons 72 enable the remote control unit user to control the speaker's attributes and characteristics. The remote control unit 71 is preferably compact and thus easily hand held enabling a user to hold and point it at the control module and activate it to send the desired control signal to the control module 67. This control may be exercised while the user is standing below the speaker without having to climb up to gain physical access to the speaker. This control may also be exercised over any individual speaker independently of the others. The remote control signal is preferably an infrared signal which is encoded and which is received by the coded data stream receiver (or sensor) 74 on the electronic control module 67. The remote control also preferably includes a funnel shaped cavity 73 at an end thereof for protecting the emitting device and focusing the infrared beam into a narrow fifteen to twenty degree angle. The remote control signal is also preferably pulsed at high current to increase its range. The coded data stream receiver 74 transmits the signal from the remote control unit 71 to a coded data processor 75 which processes and feeds the signal to an inverter-driver 76 which inverts and strengthens the signal and feeds it to a final stage decoder 77 which processes and decodes the signal one final time. Data processor 75, inverter-driver 76 and stage decoder 77 process the coded signal from the remote control unit 71 and feed it to a valid transmission detector 78 which determines if the signal is from a proper or designated remote control unit. If the detector 78 determines that the signal is valid, it is energized and thereby activates the display power control which activates the db meter driver 80 which sends signals to db meter array 81 turning on the lights thereof. When valid transmission ends, a display timer 82 keeps the db meter array 81 active for a few additional seconds and subsequently times out. The signal received from the valid transmission detector 78 is fed to the power, control and audio interface 84 which processes the signal and transmits it to the pass module 19 via an umbilical cord or cable 85 and umbilical cord socket 104 and into the electronic control module interface 100 of pass module 19. The umbilical cord 85 allows bi-directional communication between the pass module 19 and electronic control module 67.

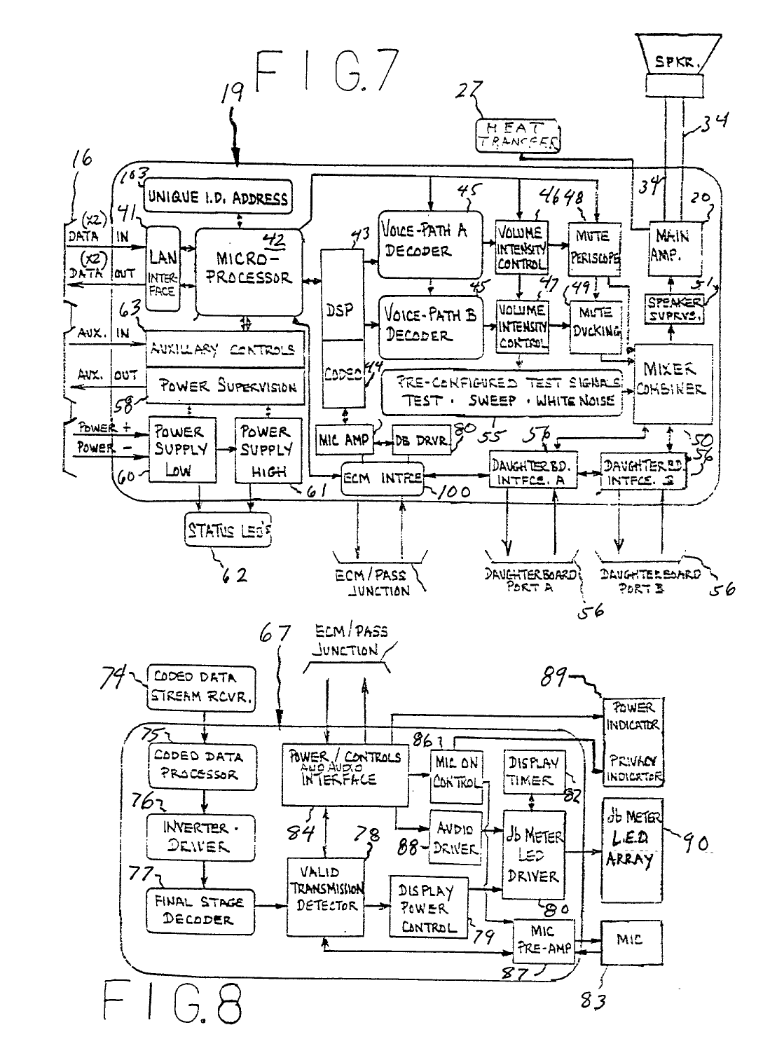

The electronic control module 67 also preferably incorporates a small microphone 83 positioned on the face thereof, as shown in FIG. 6. A special command from the pass module 19 passes through the power interface 84 and into the mic on control 86 which supplies power to the mic preamplifier 87 thereby turning on the microphone. The output of the microphone 83 is amplified by the mic preamplifier 87 and the amplified signal therefrom is transmitted back to the host controller 11 via power interface 84 and cable (junction) 85. This provides an open channel allowing the controller 11 to receive audio from the room (or other location) in which the speaker subsystem 17 is located so that personnel may monitor that area as well as receive feedback regarding acoustic aberrations in that area that may be compensated for by alteration of the equalization, contour etc. of the audio output of the speaker 18.

The electronic control module 67 also includes an audio driver 88 connected to the power interface 84 which feeds signals corresponding to the audio output from the speaker 18 into the db meter driver 80 to provide a visual indication of the sound volume output of the speaker 18 via a first set of leds 89 mounted on the face of the electronic control module 67. The leds 89 are preferably bi-color displaying red when output levels are in the upper decibel range and yellow when output levels are in the midrange and green when in the lower range. The leds work in tandem forming a circular db level indicating meter. Another set of leds 90 is mounted on the face of the electronic control module 67 and connected to the power interface 84 to provide a visual indication of high power, low power and fault condition and connected to the mic on control to provide a visual indication that the microphone is monitoring sounds in the area in order to protect the occupants' privacy. The leds are preferably bi-color displaying green for power status and orange or red when the microphone 83 is active to ensure privacy concerns are met. The leds are preferably spaced and positioned so as to be in alignment with hole perforations in the speaker grill. The display timer 82 which is connected to the db meter driver 80 controls the duration and cessation of the activation of the first set of leds 89.

The system 10 preferably includes a computer 91 connected to the host controller 11 via their ports 92 and 93 and a computer cable interconnect 101. A computer user's keyboard input to computer 91 is transmited into the host controller's 11 digital signal processor which processes the input and transmits it to the appropriate circuitry. This enables the computer user to instruct the controller 11 to, for example, lower the music volume, broadcast a lunch break message as well as alter the timing of any desired signal outputs going into the speakers 18. The computer 91 is also equipped with a modem 94 which enables it to communicate a remote computer to remotely control the system 10, if desired. The modem 94 also allows the computer 91 to communicate with remote persons or facilities to inform them of servicing needs, supplies, etc., if desired.

The mains wiring connectors 40 of the bus 16 which connect to the pass modules 19 are preferably removable plug type connector junctions. This allows the system wiring to be pre-wired and tested prior to speaker installation. For example, a hallway with forty speakers could all be pre-wired to respective plug side of connectors, tested for connection continuity and functionality and then wrapped in plastic to protect against dust, paint and other contaminants and tucked into speaker recesses. Thus, when finished painted surfaces are ready, the speakers 18 need only to be plugged in, screwed in place and turned on. Similarly, the electronic control module 67 is connected to the pass module 19 via removable plug type connectors 102. These allow ease of testing and assembly as well as interchangeability.

The pass module 19 is preferably a two-piece, non-conductive enclosure with a base and top portion. The base has a pedestal projection with two elongated holes for the purpose of receiving a conventional zip-tie connector 95 to pass therethrough. The zip-tie 95functions as a strain relief structure.

The microprocessor 97 of the host controller 11 is provided with a software program to help process and modify the output in accordance with the desired results. The host controller software program acquires instruction data from the priority override source 15 and auxiliary controls 65. The software program acquires music data and paging data from the digital signal processor 98. It reads instruction data from the priority override source 15 and/or auxiliary controls 65 relating to selection of music or paging data and in response thereto selects music or paging data. The software program sends the music or paging data to the digital signal processor 98 and commands the digital signal processor and/or network circuitry 99 to process music or paging data. The software program reads instruction data from the priority override source 15 and/or auxiliary controls 65 relating to parameters of audio output and in response thereto commands the digital signal processor 98 and/or network circuitry 99 to modify parameters of music and/or paging data accordingly. It reads instruction data from the auxiliary controls 65 relating to selection of speaker subsystem. It acquires data from a host controller databank relating to ID address of speaker subsystems and selects appropriate ID address. It commands the digital signal processor 98 and/or network circuitry 99 to produce ID address signal output.

The microprocessor 42 of the pass modules 19 also has a software program to help process and modify the audio output in accordance with programmed instructions and with input from the host controller 11 and the external control module 67. The pass module software program acquires data from the host controller 11 relating to specific ID address and acquires data from the unique ID address unit relating to the ID address for the particular pass module. The software program compares the ID address transmitted from the host controller 11 with the ID address from the unique ID address unit 103 and if it determines that that ID address from the host controller 11 is the same as that from the unique ID address unit 103 commands the microprocessor 42 to process the music and paging data. The microprocessor 42 processes or does not process the music and paging data in accordance with the determination. The pass module software program acquires music and paging data from the host controller 11 via the lan interface 41. The pass module software program also acquires instruction data from the host controller 11 via the lan interface 41. It reads instructions from the host controller 11 relating to modifying parameters of audio output. It determines the appropriate pass module component to accomplish the goals of the instructions. It sends the music and paging data to the digital signal processor 43, voice path decoders 45, volume intensity controls 46 and 47 and/or the mute, periscope and ducking 48 and 49 components and commands the digital signal processor 42, voice path decoders 45, volume intensity controls 46 and 47 and/or the mute, periscope and ducking 48 and 49 components to modify the audio output signals accordingly. The pass module software program also acquires instruction data from the auxiliary controls 63. It reads the instruction data and similarly determines the appropriate pass module component to accomplish the goals of the instructions and commands the digital signal processor 42, voice path decoders 45, volume intensity controls 46 and 47 and/or the mute, periscope and ducking components 48 and 49 to modify the audio output signals accordingly. The pass module software program also acquires instruction data from the electronic control module interface 100. It reads the instruction data and similarly determines the appropriate pass module component to accomplish the goals of the instruction and commands the digital signal processor 42, voice path decoders 45, volume intensity controls 46 and 47 and/or the mute periscope and ducking components 48 and 49to modify the audio output signals or commands the pre-configured test signal circuit 55 to produce an output corresponding to the goals of the instructions.

Accordingly, there has been provided, in accordance with the invention, a system for distributing audio to various sites inside and outside a facility and for providing remote control capability to the system that fully satisfies the objectives set forth above. It is to be understood that all terms used herein are descriptive rather than limiting. Although the invention has been specifically described with regard to the specific embodiment set forth herein, many alternative embodiments, modifications and variations will be apparent to thosed skilled in the art in light of the disclosure set forth herein. Accordingly, it is intended to include all such alternatives, embodiments, modifications and variations that fall within the spirit and scope of the invention set forth in the claims hereinbelow.

What is claimed is:

1. A system for distributing audio signals to a plurality of speakers, comprising:
a source of audio signals;
a host controller connected to said source of audio signals for receiving input therefrom and converting to digital signal output;
a plurality of speakers;
a plurality of pass modules connected to said plurality of speakers for operation and control thereof;
a wiring network interconnecting said controller and said plurality of pass modules for transmission of the digital signal outputs therethrough to said plurality of pass modules to produce desired audio output from said plurality of speakers.

2. The system of claim 1 further including a computer connected to said host controller for transmitting control commands thereto.

3. The system of claim 1 wherein said wiring network includes a bus interconnecting said main controller and said plurality of pass modules in series.

4. The system of claim 1 wherein said wiring network includes twisted-pair telephone wiring providing bidirectional transmission capability between said plurality of pass modules and said host controller.

5. The system of claim 1 wherein said plurality of pass modules are mounted on said plurality of speakers.

6. The system of claim 1 further including a plurality of heat transfer structures mounted on said plurality of pass modules and a plurality of attachment posts, said plurality of attachment posts mounted on said plurality of pass modules for connecting said plurality of pass modules to said plurality of speakers, said plurality of attachment posts having a plurality of openings for engaging said plurality of heat transfer structures for dissipation of heat therethrough and through said plurality of speakers.

7. The system of claim 1 wherein said plurality of pass modules includes a plurality of amplifiers for driving said plurality of speakers, said plurality of amplifiers allowing use of wiring in said wiring network for low voltage transmission of twenty-four volts or less.

8. The system of claim 1 wherein said host controller includes a digital signal processor for adjusting audio parameters of the audio signal.

9. The system of claim 1 wherein said host controller includes an encoder for encoding the input from the source of audio signal and wherein said plurality of pass modules have a plurality of decoders for decoding the digital signal.

10. The system of claim 1 wherein each of said plurality of pass modules has an ID address which is distinct from that of each other of said plurality of pass modules so that solely desired pass modules are responsive to desired outputs from said host controller.

11. The system of claim 10 wherein each of said plurality of pass modules includes detector logic circuitry for detecting a missing ID address thereof and generating a fault notice for transmission to said host controller.

12. The system of claim 1 wherein said plurality of pass modules have a plurality of daughterboard ports allowing installation of various desired cards therein for providing various additional desired functions thereto.

13. The system of claim 1 wherein each of said plurality of speakers includes two voice coils for receiving two signals via two signal paths from said plurality of pass modules.

14. The system of claim 1 wherein said plurality of speakers includes a plurality of sets of indicator lamps mounted thereon for displaying desired parameters of operation thereof.

15. A system for distributing audio signals to a plurality of speakers and providing remote control thereof, comprising:
a source of audio signals;
a host controller connected to said source of audio signals for receiving audio signal input therefrom and converting to digital signal output;
a plurality of speakers;
a plurality of pass modules connected to said plurality of speakers for operation and control thereof;
a wiring network interconnecting said host controller and said plurality of pass modules for transmission of the digital signal outputs therethrough to said plurality of pass modules to produce desired audio output from said plurality of speakers;
a remote control transmitter for emitting a wireless remote control signal;
a plurality of external control modules mounted on said plurality of speakers, said plurality of external control modules including a plurality of sensors for receiving and converting the remote control signal to an electrical signal, said plurality of external control modules connected to said plurality of pass modules for controlling desired functions of said plurality of speakers in response to the remote control signal.

16. The system of claim 15 wherein said remote control transmitter includes a focus chamber for providing an emission beam having narrow divergence relative to effective range of the beam.

17. The system of claim 15 wherein said remote control transmitter provides an emission beam which is pulsed at high current.

18. The system of claim 15 wherein said remote control transmitter includes an encoder for encoding the remote control signal with instructions for control of said pass module and wherein said plurality of external control modules includes a plurality of decoders for decoding the remote control signal.

19. The system of claim 15 further including a first plurality of removable connectors for interconnecting said plurality of pass modules and said wiring network and a second plurality of removable connectors for interconnecting said plurality of pass modules and said plurality of external control modules.

20. The system of claim 15 wherein said wiring network includes a bus interconnecting said main processor and said wiring network in series.

21. The system of claim 15 wherein said plurality of pass modules are mounted on said plurality of speakers.

22. The system of claim 15 further including a heat transfer structure and an attachment post, said attachment post mounted on said pass module for connecting said plurality of pass modules to said plurality of speakers, said heat transfer structure providing clip-on removable connection of said pass module to said attachment post, said attachment post having an opening for receiving said heat transfer structure for dissipation of heat through frames of said plurality of speakers.

23. The system of claim 15 wherein each of said plurality of pass modules includes an amplifier for driving a particular one of said plurality of speakers that is connected thereto.

24. The system of claim 15 wherein said host controller includes a digital signal processor for processing the audio signal.

25. The system of claim 15 wherein said host controller has an encoder for encoding the input from the source of audio signal and wherein said plurality of pass modules has a decoder for decoding the digital signal outputs.

26. The system of claim 15 wherein each of said plurality of pass modules has an ID address which is distinct from those of others of said plurality of pass modules so that solely desired pass modules are responsive to desired outputs from said main controller.

27. The system of claim 15 wherein each of said plurality of speakers includes two voice coils for receiving two signals via two transmission lines from said plurality of pass modules.

28. The system of claim 15 wherein each of said plurality of speakers includes a set of indicator lamps mounted thereon for displaying desired parameters of operation or function thereof.

29. The system of claim 15 further including a computer connected to said main processor for providing commands thereto for control of all or selected individual ones of said plurality of speakers.

30. The system of claim 15 further including a microphone mounted on said external control module and connected thereto for transmission of microphone input to said pass module for control of said plurality of speakers and for monitoring of surrounding environment of said plurality of speakers and providing data therefrom to said hostss controller.

31. The system of claim 15 wherein each of said plurality of pass modules includes on-board diagnostic circuitry to enable testing and adjustment of speaker operation.

32. A system for distributing audio signals to a plurality of speakers with remote control thereof, comprising:
a computer, said computer including a modem;
a source of music signals;
a source of paging signals;
a priority override control connected to said source of paging signals;
a source of external trigger signals;
a main controller connected to said computer for receiving command input therefrom and connected to said source of music signals and said source of paging signals for receiving audio signal input therefrom and to said source of external trigger signals for receiving signal input therefrom and converting to digital signal output, said main controller including power circuitry for detection of defective individual one of said plurality pass modules and removal of signal transmission thereto, said host contoller having a programmable clock for initiation of a desired digital signal output at a desired time;
a plurality of speakers each of which has two voice coils for receiving two channels of input, one of the channels for input from said source of music signals and the other of the channels for input from said source of paging signals;
a plurality of pass modules connected to said controller for receiving output signals therefrom, each of said plurality of pass modules connected to individual ones of said plurality of speakers for operation and control thereof, said plurality of pass modules feeding the two channels of input to said plurality of speakers for independent control of the music signals and the paging signals transmitted thereto, said plurality of pass modules including a plurality of audio amplifier chips for driving said plurality of speakers, said plurality of pass modules including a plurality of pass module microprocessors for processing the output signals from said controller, said plurality of pass modules including a plurality of test signal generators, said plurality of pass modules including on-board logic circuits for periscoping, muting, ducking and priority override, said each of said plurality of pass modules having an ID address which is distinct from those of others of said plurality of pass modules so that solely desired pass modules are responsive to desired outputs from said host controller and so that said power circuitry of said host controller can remove defective ones of said plurality of pass modules, said plurality of pass modules connectable to a power source Which is autonomous with respect to said main controller;
a bus interconnecting said host controller and said plurality of pass modules in series;
a manually actuated remote control transmitter for emitting an infrared control signal, said remote transmitter including a focus chamber for focusing the infrared signal into a beam which is divergent in the range of fifteen to twenty degrees, said control signal being pulsed at high current;
a plurality of external control modules mounted on said plurality of speakers, each of said external control modules including a sensor for receiving the remote control signal, said plurality of external control modules connected to said plurality of pass modules for controlling equalization and other desired functions of said plurality of speakers in response to the infrared control signal, said plurality of external control modules including a plurality of decoders for decoding the infrared control signal and a plurality of control module microprocessors for processing the infrared control signal, said plurality of external control modules including a plurality of microphones mounted on said plurality of external control modules and connected thereto for transmission of microphone input thereto for control of said plurality of speakers and for monitoring of surrounding environment of said plurality of speakers and providing data therefrom to said host controller;
a plurality of control module strain relief connectors for mounting said plurality of external control modules onto said plurality of speakers;
a plurality of zip-tie strap strain relief connectors for interconnection of said local area network and said plurality of pass modules;
a plurality of heat transfer structures and a plurality of attachment posts, said plurality of attachment posts mounted on said plurality of pass modules for connecting said plurality of pass modules to said plurality of speakers, said plurality of attachment posts having a plurality of openings for engaging said plurality of heat transfer structures for dissipation of heat therethrough and through said plurality of speakers, said plurality of attachment posts being hollow to allow a plurality of securement structures to pass therethrough for securement of said plurality of pass modules to said plurality of speakers, said plurality of attachment posts including a plurality of insulator inserts for surrounding said plurality of securement structures to prevent electrical shorting of said plurality of pass modules via said plurality of securement structures;
a plurality of sets of indicator leds mounted in said plurality of electronic control modules, each of said indicator leds being multicolored for displaying multiple functions, each of said sets of indicator leds configured into a circular pattern for db meter display.
